(19) United States
(12) Patent Application Publication
(10) Pub. No.: US 2009/0079869 A1
(43) Pub. Date: Mar. 26, 2009

(54) IMAGE APPARATUSES CAPABLE OF INTERCOMMUNICATING AND CONTROL METHOD THEREOF

(75) Inventor: Dae-hyun Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/037,219

(22) Filed: Feb. 26, 2008

(30) Foreign Application Priority Data
Sep. 21, 2007 (KR) 2007-97009

(51) Int. Cl. H04N 5/44

(52) U.S. Cl. 348/553; 348/E05.096

(57) ABSTRACT

Image apparatuses capable of communicating with each other and a method of controlling the image apparatuses include the image apparatuses that communicate with each other using a high definition multimedia interface-consumer electronic control (HDMI-CEC) method. The keys provided to a remote controller to control a first image apparatus are mapped to a key code used to control the second image apparatus communicating with the first image apparatus. Therefore, the second image apparatus connected to the first image apparatus is also controlled by using the remote controller to control the first image apparatus.

### CROSS-REFERENCE TO RELATED APPLICATION

This application claims the benefit of Korean Application No. 2007-97009, filed Sep. 21, 2007 in the Korean Intellectual Property Office, the disclosure of which is incorporated herein by reference.

### BACKGROUND OF THE INVENTION

1. Field of the Invention

Aspects of the present invention relate to image apparatuses capable of communicating with each other and a control method thereof. More particularly, aspects of the present invention relate to image apparatuses capable of communicating with each other wherein a first image apparatus is controlled using a remote controller and a second image apparatus that communicates with the first image apparatus is also controlled using the remote controller of the first image apparatus, and a control method thereof.

2. Description of the Related Art

Conventionally, one remote controller is provided to control one image apparatus. As image apparatuses have diversified, the number of remote controllers required to control the image apparatuses has also increased. Accordingly, a user must manipulate a plurality of remote controllers in order to control a plurality of image apparatuses, and so the user experiences inconvenience when using the plurality of image apparatuses.

A method of controlling two connected image apparatuses using one remote controller has been proposed to obviate such user's inconvenience. However, a user still needs to know in advance remote controller codes provided by image apparatus manufacturers in order to be able to control the two image apparatuses by using only one remote controller, and still needs to register the provided remote controller codes in to the remote controller. Often, a method of analyzing a waveform of the remote controller code is used to register the remote controller codes in the one remote controller. However, the method of analyzing the waveform of the remote controller codes is not easy for a user, because a user has to manipulate keys provided on the first and second image apparatuses to read and store generated waveforms of the remote controller codes.

### SUMMARY OF THE INVENTION

Aspects of the present invention provide image apparatuses capable of communicating with each other, and a control method thereof, in which keys provided to a remote controller to control a first image apparatus are mapped to key codes used to control a second image apparatus, so that a user can easily control both image apparatuses using the one remote controller.

Aspects of the present invention also provide image apparatuses capable of communicating with each other, and a method of controlling the image apparatuses, wherein menus displayed by a first image apparatus are used by a user to easily map remote controller keys to control a second image apparatus connected to the first image apparatus, so that image apparatuses are controlled using the remote controller.

Additional aspects, utilities, and advantages of the present invention will be set forth in part in the description which follows and, in part, will be obvious from the description, or may be learned by practice of the invention.

The foregoing and/or other aspects and utilities of the present invention may be achieved by providing an image apparatus, comprising a communication unit to receive a key code of a remote controller that are transmitted through another image apparatus that is connected to the image apparatus; a first storage unit to store a key table in which a first key code corresponding to a first key of the remote controller and a second key code corresponding to a second key of the remote controller are mapped; and a controller to execute an operation of the image apparatus according to the mapped second key code if the first key code is received through the communication unit.

According to aspects of the present invention, the controller may map the first key code and the second key code, and register the mapped key codes to the key table if the first key code and the second key code are received through the communication unit.

According to aspects of the present invention, the communication unit may communicate with the another image apparatus using a high definition multimedia interface-consumer electronic control (HDMI-CEC) method via a connection.

According to aspects of the present invention, the image apparatus may further comprise a second storage unit to store a content, wherein the controller may control the communication unit to transmit the content to the another image apparatus according to a user command received through the another image apparatus.

The foregoing and/or other aspects and utilities of the present invention may be achieved by providing an image apparatus comprising a manipulation receiver to receive a key signal according to a manipulation of a predetermined key provided on a remote controller; and a controller to generate a menu used to map a first key and a second key provided on the remote controller.

According to aspects of the present invention, the image apparatus may further comprise a communication unit to transmit to another image apparatus connected to the image apparatus a key code corresponding to the key signal received through the manipulation receiver.

According to aspects of the present invention, the image apparatus may further comprise a signal processor to signal-process a content transmitted from the external image apparatus through the communication unit; and a display to display the content that is signal-processed by the signal processor and the menu.

According to aspects of the present invention, the communication unit may communicate with the another image apparatus using a high definition multimedia interface-consumer electronic control (HDMI-CEC) method via a connection.

The foregoing and/or other aspects and utilities of the present invention may be achieved by providing a method of controlling a first image apparatus and a second image apparatus capable of communicating with each other, the method comprising receiving a first key code and a second key code of a remote controller transmitted through the first image apparatus; mapping the first key code and the second key code; and if the first key code is received through the first image apparatus, executing an operation according to the mapped second key code.

According to aspects of the present invention, the method may further comprise embodying a menu to the first image apparatus to enable mapping the first key code and the second key code.

According to aspects of the present invention, the embodying of the menu may comprise displaying a remote control key capable of being used to control the second image apparatus on a screen of the first image apparatus.

According to aspects of the present invention, the method may further comprise storing a key table in which the first key code and the second key code are mapped.

According to aspects of the present invention, the method may further comprise determining whether or not the first image apparatus communicates with the second image apparatus.

According to aspects of the present invention, the first image apparatus and the second image apparatus may communicate with each other using a high definition multimedia interface-consumer electronic control (HDMI-CEC) method via a connection.

According to aspects of the present invention, a method of controlling a second image apparatus that is connected to the first image apparatus using a remote controller includes generating a control signal using the remote controller to control one of the functions of the second image apparatus; including a first key code of the first image apparatus that corresponds to the control signal in a command signal and forwarding the command signal to the second image apparatus via a connection between the first and second image apparatuses; referring to a key map table to determine a second key code of the second image apparatus that corresponds to the first key code, wherein the key map table contains key codes of the first image apparatus that are mapped to key codes of the second image apparatus; and performing the one of the functions of the second image apparatus that corresponds to the second key code.

According to aspects of the present invention, a method of mapping button keys of a remote controller to control functions of a first image apparatus and a second image apparatus that is connected to a first image apparatus, includes: displaying a mapping menu on a screen of the first image apparatus, the mapping menu containing graphic representations of button keys of the remote controller; selecting a first button key of the remote controller to generate an inherent key code to be forwarded to the second image apparatus via a connection; selecting a second button key of the remote controller to generate an action key code to be forwarded to the second image apparatus via the connection, mapping the inherent key code to the action key code in a key table; and recording the key table that includes the selected map of the first and second button keys.

According to aspects of the present invention, an image apparatus connectable to another image apparatus to be controlled by a remote controller, includes a communication unit to receive command signals including one of a plurality of key codes of the another image apparatus via a connection between the image apparatus and the another image apparatus; a storage unit to store a key map table containing the plurality of key codes of the another image apparatus that are mapped to respective plurality of key codes of the image apparatus; and a controller to control functions of the image apparatus that correspond to the respective plurality of key codes of the image apparatus based on one of the plurality of key codes of the another image apparatus included in the received command signals.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following description of the aspects, taken in conjunction with the accompanying drawings of which:

FIG. 1 is a view illustrating image apparatuses according to an aspect of the present invention;

FIG. 2 is a block diagram illustrating structure of image apparatuses according to an aspect of the present invention;

FIG. 3 is a view illustrating a remote control apparatus to control image apparatuses according to an aspect of the present invention;

FIGS. 4A and 4B are views illustrating menus used in controlling image apparatuses according to an aspect of the present invention; and

FIGS. 5 and 6 are flowcharts to explain operations of image apparatuses according to an aspect of the present invention.

### DETAILED DESCRIPTION OF THE EMBODIMENTS

Reference will now be made in detail to aspects of the present invention, examples of which are illustrated in the accompanying drawings, wherein like reference numerals refer to the like elements throughout. The aspects are described below in order to explain the present invention by referring to the figures.

In various aspects, image apparatus refers to a device that displays, processes, records, reproduces an image, for example, or combinations thereof. Accordingly, image apparatus may include a television, a computer, a multimedia device, a cell phone, a personal digital assistant (PDA), a display, a DVD player, or similar devices.

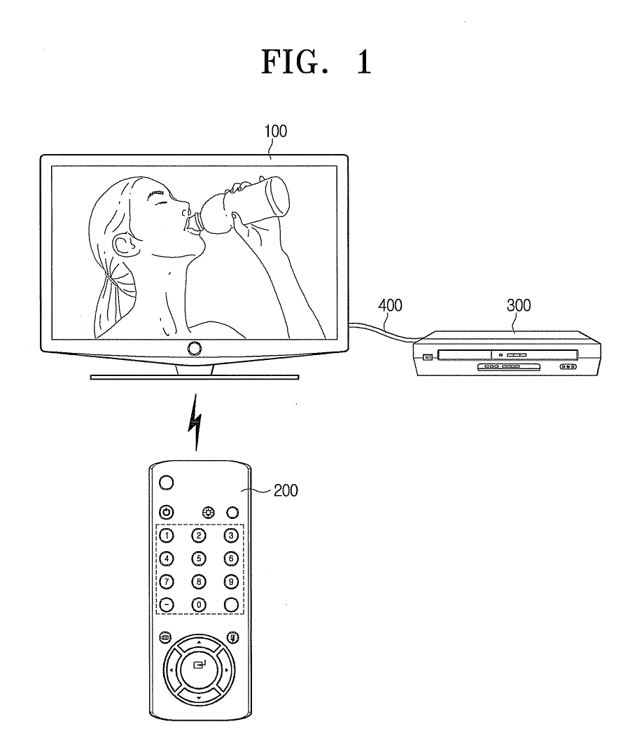

FIG. 1 is a view illustrating image apparatuses according to an aspect of the present invention. Referring to FIG. 1, a first image apparatus 100 and a second image apparatus 300 according to an aspect of the present invention are connected via a high definition multimedia interface (HDMI) cable 400. The two apparatuses 100 and 300 are capable of communicating with each other by way of the HDMI cable, for example.

The first image apparatus 100 may be a sink device (e.g., a destination device, or a device that receives data) having a display function, such as a television (TV) or a monitor, for example. A user controls the first image apparatus 100 by manipulating a remote controller 200, for example. The first image apparatus 100 provides the user with various kinds of content transmitted in response to a user command from a second image apparatus 300, for example. The various kinds of contents may be multimedia content with images and audio. If a user manipulates a key of the remote controller 200, a key code corresponding to the manipulated key is transmitted to the first image apparatus 100, and the first image apparatus 100 performs an operation corresponding to the received key code. In various aspects, a content refers to data, or multimedia data, including images, videos, audios, or combinations thereof.

The second image apparatus 300 may be a source device (e.g., an origin device, or a device from which data originates) such as an audio and video (AV) receiver, or a home theater system (HTS), for example. The user controls the second image apparatus 300 by also manipulating the remote controller 200 used to control the first image apparatus 100. The second image apparatus 300 transmits the various kinds of content to the first image apparatus 100 according to the user command. In various aspects, the second image apparatus 300 may be, or include, an optical disc player or a game system, for example.

When using the remote controller 200 to control both the first image device 100 and the second image device 200, if a user manipulates a key of the remote controller 200, a key code corresponding to the manipulated key is transmitted to the first image apparatus 100 so that the first image apparatus 100 receives the key code. In turn, the first image apparatus 100 transmits the received key code along with (or within) a high definition multimedia interface-consumer electronic control (HDMI-CEC) command (hereinafter referred to as a command), for example, to the second image apparatus 300 via a consumer electronic control (CEC) line of the HDMI cable 400. The second image apparatus 300 then performs an operation corresponding to the key code received from the first image apparatus 100.

Herein, the user sets whether to control the first image apparatus 100 or the second image apparatus 300 by way of the remote controller 200 through a menu that enables the user to select an apparatus (such as the second image apparatus 300) capable of being operated by the first image apparatus 100. The menu to select the apparatus displays various external apparatuses, such as the first image apparatus 100 and the second image apparatus 300 connected to the first image apparatus 100. If the user selects the first image apparatus 100 from the menu, the user then controls the first image apparatus 100 using the remote controller 200. On the other hand, if the user selects an external apparatus that is connected to the first image apparatus 100, the user then controls the selected external apparatus using the remote controller 200. To select the first image apparatus 100 or an external apparatus connected to the first image apparatus 100, the user manipulates a key to select an apparatus. Accordingly, the user may control the first image apparatus 100 or the external apparatus. In various aspects, the external apparatus may be the second image apparatus 300.

To enable the control of the first image apparatus 100 and the second image apparatus 300 connected to the first image apparatus 100, the first image apparatus 100 has a key mapping menu (discussed below) to map keys of the remote controller 200 to functions of the second image apparatus 300. That is, in order to control the second image apparatus 300 the user sets (or selects) the keys of the remote controller 200 using the key mapping menu so that the set (or selected) keys of the remote controller 200 are used to control the second image apparatus 300. The above method may be implemented utilizing keys that are not used to control the first image apparatus 100 to control the second image apparatus 300, for example, which will be explained in detail below. In various aspects, the mapping of the keys of the remote controller 200 may be performed prior to performing control of the first image apparatus 100 and the second image apparatus 300 connected to the first image apparatus 100 using the remote controller 200.

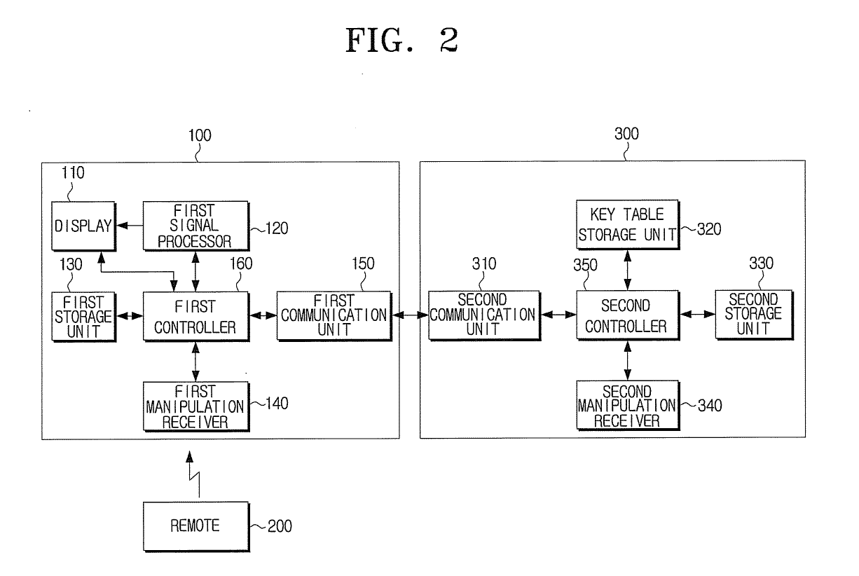

FIG. 2 is a block diagram illustrating structure of image apparatuses according to an aspect of the present invention. Referring to FIG. 2, the first image apparatus 100 may include a display 110, a first signal processor 120, a first storage unit 130, a first manipulation receiver 140, a first communication unit 150, and a first controller 160.

The first communication unit 150 communicates with the second image apparatus 300, transmits various commands (e.g., the HDMI-CEC commands) to control the second image apparatus 300, and receives various kinds of content transmitted from the second image apparatus 300. According to an aspect of the present invention, the first communication unit 150 uses a HDMI method, and the two image apparatuses 100 and 300 communicate with each other by a wired connection, though such is not necessary. Thus, the communication between the two image apparatuses 100 and 300 may be by way of a wireless communication method. The commands transmitted to the second image apparatus 300 include a key code of the remote controller 200, and use a control command in an HDMI-CEC standard.

The first signal processor 120 processes a signal of the content transmitted from the second image apparatus 300 through the first communication unit 150, and outputs the processed signal. That is, the first signal processor 120 signal-processes video data and audio data included in the content, and outputs the signal-processed video data and audio data, for example.

The display 110 scales the content that is signal-processed by the first signal processor 120, and displays the scaled content on a screen (not shown) of the display 110. The display 110 displays various menus generated by the first controller 160 on the screen to be viewed by a user, which will be explained below. Accordingly, the display 110 displays on the screen, a key mapping menu used to map keys of the remote controller 200 to functions of the second image apparatus 300.

The first storage unit 130 stores a control program and data required to control the first image apparatus 100. The first storage unit 130 stores a user control code table as illustrated in Table 1. The user control code table is compliant with the HDMI-CEC standard. The key code (Operation ID) is included in the command from the first communication unit 150, and is transmitted to the second image apparatus 300.

TABLE 1

| Operation ID | User Operation |
|---|---|
| 0x00 | Select |
| 0x01 | Up |
| 0x02 | Down |
| 0x03 | Left |
| . . . | . . . |
| 0x77 | Reserved |

The first manipulation receiver 140 receives the key code transmitted from the remote controller 200, and transmits the received key code to the first controller 160. The first manipulation receiver 140 receives the key code of a pulse form from the remote controller 160. The keys provided on the remote controller 200 have different respective pulse forms. That is, the keys provided to the remote controller 200 have different key codes (for example, as shown as the Operation ID of Table 1), and each of the different key codes corresponds to different functions (for example, as shown as the User Operation of Table 1).

The first controller 160 receives a key code, which is received through the first manipulation receiver 140, and controls various devices included in the first image apparatus 100 to execute functions corresponding to the received key codes. The first controller 160 enables the key code received from the remote controller 200 to be included in the command to be transmitted to the second image apparatus 300, and transmits the command that includes the key code. Further, to map a predetermined key of the remote controller 200 to a predetermined function of the second image apparatus 300, the first controller 160 generates a key mapping menu, and displays the generated key mapping menu on the display.

To map a predetermined key of the remote controller 200 to a predetermined function of the second image apparatus 300, the keys of the remote controller 200 are displayed (or represented) on the key mapping menu. At this point, if a user selects a first key displayed on the key mapping menu, a key code corresponding to the first key is transmitted to the second image apparatus 300 through the first communication unit 150. Then, keys of the remote controller 200 that are capable of being used on (or capable of being used to control) the second image apparatus 300 are displayed on the key mapping menu. If a user then selects a second key from among the displayed keys on the key mapping menu, a key code corresponding to the second key is transmitted to the second image apparatus 300 through the first communication unit 150. Hereinafter, the first key selected by a user will be referred to as an inherent key to execute inherent functions stored at the user control code table, and the second key will be referred to as an action key corresponding to a function of the second image apparatus 300 to be mapped.

According to aspects of the present invention, the first key corresponds to a desired function to be performed by the second image apparatus 300, and the second key corresponds to one that will actually cause the second image apparatus 300 to perform the desired function. That is, if a user desires to set a key that will cause performance of a fast forward function for the second image apparatus, the user will first select a key, such as [symbol] that is typically associated with the fast forward function as the first key. Then, the user will select another key that the user desires to cause performance of the fast forward function in the second image apparatus 300 as the second key. In various aspects, a key on the remote controller 200 that is not used to control the first image device 100 may be used to control the second image device 300. Accordingly, the key on the remote controller 200 is mapped to a function of the second image device 300 by using the key mapping menu to create the key map.

Again, referring to FIG. 2, the second image apparatus 300 according to an aspect of the present invention may include a second communication unit 310, a key table storage unit 320, a second storage unit 330, a second manipulation receiver 340, and a second controller 350. The second communication unit 310 communicates with the first image apparatus 100, receives various commands transmitted from the first image apparatus 100, transmits the received commands to the second controller 350, and receives various types of content from the first image apparatus 100 under the control of the second controller 350. The second communication unit 310 uses the HDMI method. Aspects of the present invention may use a wire communication method, but such is not necessary, as a wireless communication method may also be used. The commands transmitted to the first image apparatus 100 includes a key code of the remote controller 200, and use a control command in an HDMI-CEC standard.

The second manipulation receiver 340 also includes various keys to manually control the operation of the second image apparatus 200. Accordingly, a user may control the second image apparatus 300 by manipulating the second manipulation receiver 340 without having to manipulate (or use) the remote controller 200. The second storage unit 330 stores various control programs and data to control the operation of the second image apparatus 300. The second storage unit 330 stores a user control code table as illustrated in Table 1 shown above. The second storage unit 330 stores various contents received via various paths. The contents stored in the second storage unit 330 are transmitted to the first image apparatus 100 under the control of the second controller 350.

The key table storage unit 320 stores a key table containing the mapped key codes as illustrated in Table 2. If a user selects a first key displayed on the key mapping menu of the first image apparatus 100, the key code corresponding to the first key is registered to the key table as an inherent key code, and if a user selects a second key, the key code corresponding to the second key is mapped with respect to the inherent key code, and is registered to the key table as an action key code that corresponds to the inherent key code.

TABLE 2

| Inherent key code | Action key code |
|---|---|
| 0x02 | 0x00 |
| 0x03 | 0x01 |
| . . . | . . . |

The second controller 350 controls components of the second image apparatus 300 according to the various commands received through the second communication unit 310 and according to a user command received through the second manipulation unit 340. That is, for a mapping operation, the second controller 350 receives the command containing the inherent key code and the command containing the action key code through the second communication unit 310, maps the inherent key code and action key code, and registers the mapped key codes to the key table (such as table 2). Thereafter, if a user manipulates the inherent key of the remote controller 200 to control the second image apparatus 300, the inherent key code is received through the second communication unit 310, the second controller 350 checks the key table, and the second controller 350 controls the components of the second image apparatus 300 to execute an operation thereof according to the action key code that is correspondingly mapped with respect to the inherent key code.

As described above, a user controls the first image apparatus 100 by using the remote controller 200, and maps functions of the second image apparatus 300 to keys of the remote controller 200, so that the second image apparatus 300 is controlled by the user using the remote controller 200.

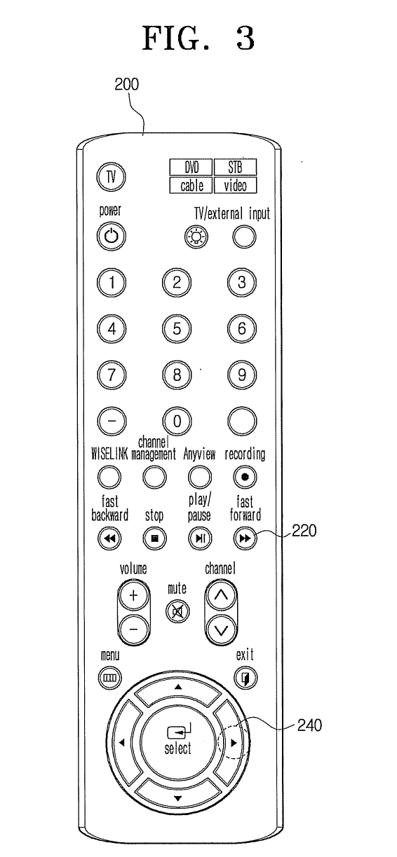

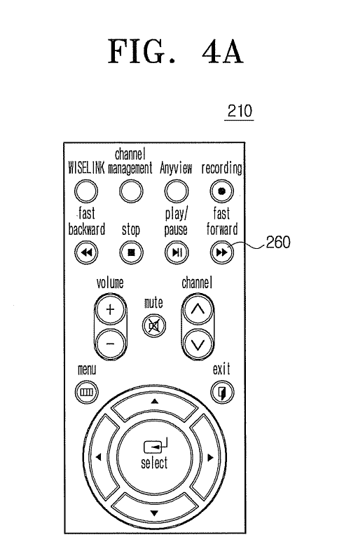

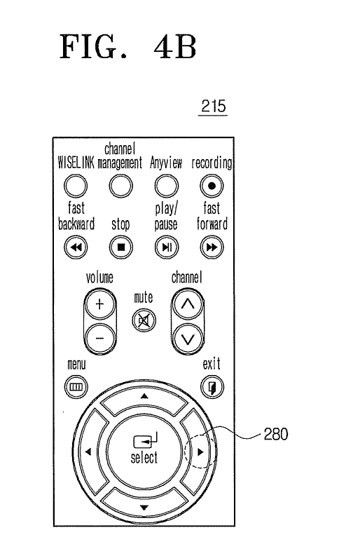

FIG. 3 is a view illustrating a remote control apparatus to control image apparatuses according to an aspect of the present invention. FIGS. 4A and 4B are views illustrating menus used in controlling image apparatuses according to an aspect of the present invention.

FIG. 3 depicts the remote controller 200 used to control the first and second image apparatuses 100 and 300. FIG. 4A depicts an example of a key mapping menu 210 that displays keys provided on the remote controller 200. FIG. 4B depicts an example of a key mapping menu 215 that displays keys capable of being used to control the second image apparatus 300.

During a mapping operation, if a key mapping menu 210 of FIG. 4A is displayed on the first image apparatus 100 by the manipulation of a predetermined key of the remote controller 200, a user presses (or uses) arrow keys ( [symbol] , ▴, ▾) of the remote controller 200 to navigate to and select an inherent key, for example, a Fast forward key 260. In an alternate manner, rather than using the key mapping menu 210 of FIG. 4A to graphically select the Fast forward key 260, a user may press an actual Fast forward key 220 on the remote controller 200 to register or select the Fast forward key 220 as an inherent key.

Afterwards, if the key mapping menu 215 of FIG. 4B is displayed on the first image apparatus 100 which displays selectable keys, the user may selects an action key for the just selected inherent key (for example, the arrow key ( [symbol] ), by again using the arrow keys ( [symbol] ▴, ▾) of the remote controller 200 to navigate to a desired key to be a corresponding action key, for example. Alternatively, the user may simply press the arrow key ( [symbol] ) 240 on the remote controller 200 to register the arrow key ( [symbol] ) 240 as the action key.

If the inherent key and the action key are selected as described above, an inherent code corresponding to the inherent key and an action code corresponding to the action key are transmitted along with (or included in) the command from the first image apparatus 100 to the second image apparatus 300. The second controller 350 then maps the inherent code and the action code, and registers the mapped codes to the key table stored in the key table storage unit 320.

With the above mapped codes, if a user then presses the Fast forward key 220 on the remote controller 200 to control the second image apparatus 300, the corresponding key code is transmitted to the second image apparatus 300 through the first image apparatus 100. The second image apparatus is controlled to perform a corresponding function according to the action key code mapped with respect to the inherent key code of the pressed Fast forward key 220. That is, a user presses the Fast forward key 220 to control the second image apparatus 300, the function corresponding to the key [symbol] 240 is performed.

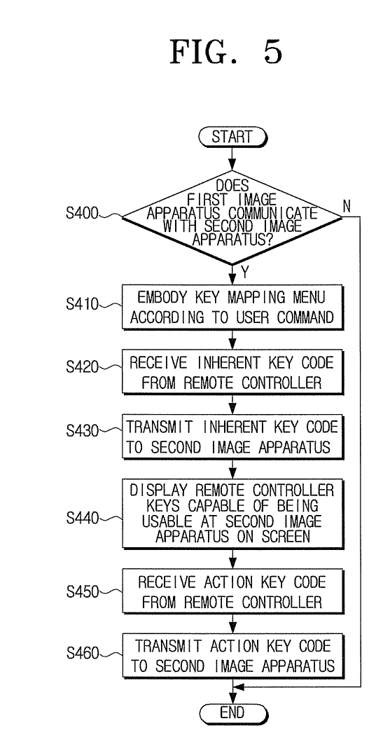

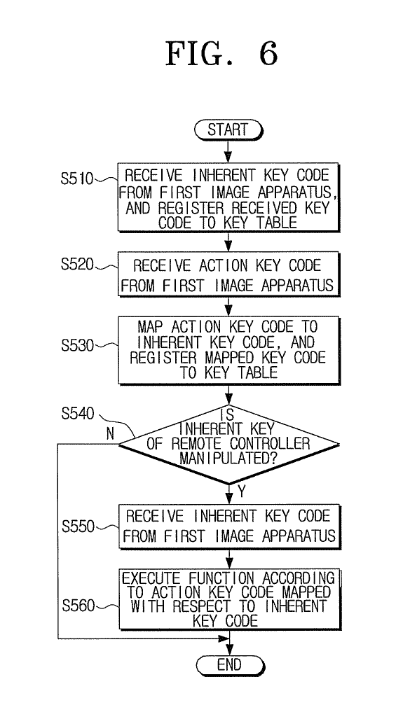

FIGS. 5 and 6 are flowcharts to explain operations of image apparatuses according to an aspect of the present invention. Referring to FIG. 5, in operation S400, if the first controller 160 determines that the first image apparatus 100 communicates with the second image apparatus 300, in operation S410, the first controller 160 controls the display 110 to embody (or display) a key mapping menu, according to a user command input through the remote controller 200. That is, the first controller 160 controls the display 110 so that the key mapping menu 210 of FIG. 4A is displayed on the display 110.

In operation S420, the first controller 160 receives an inherent key code from the remote controller 200 through the first manipulation receiver 140. In operation S430, the first controller 160 controls the first communication unit 150 to transmit the inherent key code to the second image apparatus 300.

In operation S440, the first controller 160 controls the display 110 to display on the screen, remote controller keys that are capable of being used with the second image apparatus 300. In operation S450, the first controller 160 receives the action key code from the remote controller 200, and in operation S460, the first controller 160 controls the first communication unit 150 to transmit the action key code to the second image apparatus 300.

Referring to FIG. 6, in operation S510, the second controller 350 receives the inherent key code from the first image apparatus 100 through the second communication unit 310, and registers the received key code to the key table stored in the key table storage unit 320. Operation S510 is performed after operation S430 of FIG. 5 is performed.

In operation S520, the second controller 350 receives the action key code from the first image apparatus 100. Operation S520 is performed after operation S460 of FIG. 5 is performed.

In operation S530, the second controller 350 maps the action key code to the inherent key code, and registers the mapped key code to the key table. In operation S540, if a user manipulates the inherent key of the remote controller 200, in operation S550, the second controller 350 receives the inherent key code from the first image apparatus 100. In operation S560, the second controller 350 controls the second image apparatus 300 to execute the function corresponding to the action key code mapped with respect to the inherent key code.

An inherent key of the remote controller 200 is mapped to an action key to control the second image apparatus 300 in order to control the second image apparatus 300 to execute the functions corresponding to a manipulation of the action key as described in the processes of FIGS. 5 and 6. Accordingly, the remote controller is programmed to control functions of the second image apparatus by using a mapping menu to create a key map table of keys of the remote controller.

In various aspects, the desired function to be performed by the second image apparatus is represented by the inherent key, and the key (on a remote control) that will cause the second image apparatus to perform the desired function is the action key. That is, in order to map a fast forward function to a right arrow key ( [symbol] ) for the second image apparatus, as discussed in the application, a) when using the mapping menu, the fast forward key ( [symbol] ) 260 may be selected first, then, the right arrow key ( [symbol] ) 280 may be selected subsequently; or b) if using the remote controller 200 directly, the fast forward key ( [symbol] ) 220 may be selected first, then, the right arrow key ( [symbol] ) 240 may be selected.

In various aspects, the vice versa is also possible, whereby the action key is selected first, then the inherent key is subsequently selected.

In various aspects, the mapping menu need not be displayed on the first image apparatus, but rather, may be displayed on a screen of the remote controller. In other aspects, the remote controller may be a device with a remote control function, such as a cell phone.

Keys provided to a remote controller to control a first image apparatus are mapped to a key code used to control a second image apparatus communicating with the first image apparatus. Therefore a user can easily control the second image apparatus, and can map the remote controller keys using a key mapping menu displayed on the first image apparatus.

Although a few aspects of the present invention have been shown and described, it would be appreciated by those skilled in the art that changes may be made in these aspects without departing from the principles and spirit of the invention, the scope of which is defined in the claims and their equivalents.

What is claimed is:

1. An image apparatus, comprising:
a communication unit to receive key codes of a remote controller that are transmitted through another image apparatus that is connected to the image apparatus;
a first storage unit to store a key table in which a first key code corresponding to a first key of the remote controller and a second key code corresponding to a second key of the remote controller are mapped; and
a controller to execute an operation of the image apparatus according to the mapped second key code if the first key code is received through the communication unit.

2. The image apparatus of claim 1, wherein the controller maps the first key code and the second key code, and registers the mapped key codes to the key table if the first key code and the second key code are received through the communication unit.

3. The image apparatus of claim 1, wherein the communication unit communicates with the another image apparatus using a high definition multimedia interface-consumer electronic control (HDMI-CEC) method via a connection.

4. The image apparatus of claim 1, further comprising:
a second storage unit to store a content,
wherein the controller controls the communication unit to transmit the content to the another image apparatus according to a user command received through the another image apparatus.

5. An image apparatus comprising:
a manipulation receiver to receive a key signal according to a manipulation of a predetermined key provided on a remote controller; and
a controller to generate a menu used to map a first key and a second key provided on the remote controller.

6. The image apparatus of claim 5, further comprising:
a communication unit to transmit to another image apparatus connected to the image apparatus a key code corresponding to the key signal received through the manipulation receiver.

7. The image apparatus of claim 6, further comprising:
a signal processor to signal-process a content transmitted from the another image apparatus through the communication unit; and
a display to display the content that is signal-processed by the signal processor and the menu.

8. The image apparatus of claim 6, wherein the communication unit communicates with the another image apparatus using a high definition multimedia interface-consumer electronic control (HDMI-CEC) method via a connection.

9. A method of controlling a first image apparatus and a second image apparatus capable of communicating with each other, the method comprising:
receiving a first key code and a second key code of a remote controller transmitted through the first image apparatus;
mapping the first key code and the second key code; and
if the first key code is received through the first image apparatus, executing an operation according to the mapped second key code.

10. The method of claim 9, further comprising:
embodying a menu to the first image apparatus to enable mapping the first key code and the second key code.

11. The method of claim 10, wherein the embodying of the menu comprises:
displaying a remote control key capable of being used to control the second image apparatus on a screen of the first image apparatus.

12. The method of claim 9, further comprising:
storing a key table in which the first key code and the second key code are mapped.

13. The method of claim 9, further comprising:
determining whether the first image apparatus communicates with the second image apparatus.

14. The method of claim 9, wherein the first image apparatus and the second image apparatus communicate with each other using a high definition multimedia interface-consumer electronic control (HDMI-CEC) method via a connection.

15. A method of controlling a second image apparatus that is connected to the first image apparatus using a remote controller, the method comprising:
generating a control signal using the remote controller to control one of the functions of the second image apparatus;
including a first key code of the first image apparatus that corresponds to the control signal in a command signal and forwarding the command signal to the second image apparatus via a connection between the first and second image apparatuses;
referring to a key map table to determine a second key code of the second image apparatus that corresponds to the first key code, wherein the key map table contains key codes of the first image apparatus that are mapped to key codes of the second image apparatus; and
performing the one of the functions of the second image apparatus that corresponds to the second key code.

16. The method of claim 15, wherein the command signal is in a high definition multimedia interface-consumer electronic control (HDMI-CEC) standard and the connection is a high definition multimedia interface (HDMI) cable.

17. A method of mapping button keys of a remote controller to control functions of a first image apparatus and a second image apparatus that is connected to a first image apparatus, comprising:
displaying a mapping menu on a screen of the first image apparatus, the mapping menu containing graphic representations of button keys of the remote controller;
selecting a first button key of the remote controller to generate an inherent key code to be forwarded to the second image apparatus via a connection;
selecting a second button key of the remote controller to generate an action key code to be forwarded to the second image apparatus via the connection,
mapping the inherent key code to the action key code in a key table; and
recording the key table that includes the selected map of the first and second button keys.

18. The method of claim 17, wherein the connection is a high definition multimedia interface (HDMI) cable.

19. An image apparatus connectable to another image apparatus to be controlled by a remote controller, comprising:
a communication unit to receive command signals including one of a plurality of key codes of the another image apparatus via a connection between the image apparatus and the another image apparatus;
a storage unit to store a key map table containing the plurality of key codes of the another image apparatus that are mapped to respective plurality of key codes of the image apparatus; and
a controller to control functions of the image apparatus that correspond to the respective plurality of key codes of the image apparatus based on one of the plurality of key codes of the another image apparatus included in the received command signals.

20. The image apparatus of claim 19, further comprising a high definition multimedia interface (HDMI) cable as the connection.

21. The image apparatus of claim 19, wherein the remote controller is programmed to control functions of the image apparatus by use of a displayable mapping menu to create the key map table.
